(19) United States
(12) Patent Application Publication
(10) Pub. No.: US 2023/0366772 A1
(43) Pub. Date: Nov. 16, 2023

(54) METHOD FOR ASSESSING THE SERVICE LIFE OF A TURBINE ENGINE PART

(71) Applicant: SAFRAN AIRCRAFT ENGINES, Paris (FR)

(72) Inventors: Aniss Chafik KESSACI, Moissy-Cramayel (FR); Jean Arthur Sébastien NAY, Moissy-Cramayel (FR)

(73) Assignee: SAFRAN AIRCRAFT ENGINES, Paris (FR)

(21) Appl. No.: 18/033,676

(22) PCT Filed: Oct. 25, 2021
(86) PCT No.: PCT/FR2021/051866

§ 371 Date: Apr. 25, 2023

(30) Foreign Application Priority Data
Oct. 26, 2020 (FR) 2010950

(51) Int. Cl. G01M 5/00; G01M 15/14

(52) U.S. Cl. CPC G01M 5/0033; G01M 15/14

(57) ABSTRACT

The invention describes a method for assessing the service life (DDV) of a turbine engine part, comprising the following steps: S1: determining average damage to the part over time (E_moy(t)) from stresses applied to the part on the basis of wear of the part (σ(u)) and a law of variation in the wear of the part over time (u(t)); S3: determining cumulative damage (E_cum) to the part corresponding to damage on breaking (E_rupt) of the part, the cumulative damage (E_cum) corresponding to the integral of the average damage over time (E_moy(t)) between an initial time (t_0) and an end time (t_rupt): E_cum=E_rupt=Formula (1); and S4: inferring the service life (DDV) of the part, the service life (DDV) corresponding to the end time (t_rupt).

### FIELD OF THE INVENTION

This invention relates to the field of turbomachines. It aims in particular to evaluate the lifetime of a turbomachine part taking into account the development of wear over the turbomachine operating time.

### PRIOR ART

During the operation of a turbomachine, its parts undergo forces, rubbing and mechanical stresses. The parts can therefore wear out gradually over the turbomachine operating time. The turbomachine operating time in which the parts are assembled is conventionally measured in numbers of turbomachine operating cycles.

Wear is liable to modify the part geometry, i.e. its outer surface, for example when the wear appears as rub marks hollowing out the part over a certain depth and/or as surface irregularities.

A new part, which has not yet undergone any turbomachine operating cycle, has zero wear. The wear of the part increases over the operation of the turbomachine, until it causes the failure of the part.

The damage of the part is a value representative of the wear of the part. The damage varies between zero damage for an unworn part, and damage at failure of the part.

Firstly, the part undergoes incipient damage, i.e. damage without modification of the part geometry, the part having a geometry equivalent to its geometry on leaving the factory. Secondly, the part undergoes propagating damage, i.e. damage of the part once its geometry has been modified, for example by the appearance of a rub mark characteristic of wear.

The lifetime of a part is equivalent to the number of turbomachine operating cycles that the part can withstand before its failure, i.e. the number of turbomachine operating cycles that the part can withstand before its damage reaches damage at failure.

Evaluating the lifetime of a turbomachine part makes it possible to define maintenance criteria to return the part to flight, or contrariwise to withdraw it from use for the purpose of its maintenance or replacement.

At present, the lifetime of turbomachine parts is evaluated based on the stresses and temperature to which the part is subjected, making the assumption that the part geometry remains constant over the operation of the turbomachine. In this method, the lifetime of the part is therefore determined for a given geometry, without taking into account any possible development of the wear of the part, and therefore of its geometry, during the subsequent operation of the turbomachine. The stresses applied to the part, i.e. the stresses inside the part, are estimated for this determined part geometry. The stresses applied to the part are therefore constant with the turbomachine operating time.

Moreover, another assumption is that the average damage of the part per turbomachine operating cycle is supposed constant, i.e. the cumulative damage of the part is supposed to vary linearly with the turbomachine operating time, until the failure of the part.

Thus, this current method simply evaluates a lifetime of the part for a given geometry, without taking into account the probable development of wear of the part and therefore its geometry over time.

However, certain parts of the turbomachine have their geometry affected by the development of wear over the turbomachine operating time. For example, wears with small amounts of travel in the low-pressure compressor discs are developing wears, which modify the part geometry.

The stresses applied to the part, based on which the lifetime of the part is evaluated, depend on the part geometry. Consequently, the lifetime of the part depends on the variation of the part geometry, and therefore the development of its wear, with the turbomachine operating time.

The damage to the part, in particular the propagating damage once the wear has appeared, does not therefore vary linearly with time. Specifically, the greater the wear exhibited by the part, the greater the stresses applied to the part (stress concentration effect), so the greater the damage of the part per turbomachine operating cycle. The curve representing the propagating damage as a function of time is therefore increasing and convex, and non-linear.

Thus, the current method does not make it possible to accurately evaluate the lifetime of a part having wear that develops with the turbomachine operating time and for which the stresses applied to the part depend on its wear.

Consequently, to avoid the risk of keeping parts liable to fail, these parts must be withdrawn from use early, without carrying out an optimal number of flight hours. The parts must be frequently repaired or changed. The number of unavailable parts is considerable, the maintenance costs are high, and the maintenance is burdensome since it must be done frequently.

### DISCLOSURE OF THE INVENTION

One aim of the invention is to make provision for a method for evaluating a lifetime of a turbomachine part allowing a more accurate evaluation of the part lifetime by comparison with the prior art, taking into account the development of the wear of the part as a function of turbomachine operating time.

Another aim of the invention is to make provision for a method for evaluating a lifetime of a turbomachine part making it possible to develop improved maintenance criteria.

The invention relates to a method for evaluating a lifetime of a turbomachine part, comprising the following steps:
S1: determining an average damage of the part as a function of time based on a relationship expressing the stresses applied to the part as a function of a wear of the part and of a relationship expressing the wear of the part as a function of time;
S2: determining a damage at failure of the part;
S3: determining a cumulative damage of the part corresponding to the damage at failure of the part, said cumulative damage corresponding to the integral of the average damage as a function of time between an initial time and a final time: E_cum=E_rupt=∫_{t_0}^{t_rupt} E_moy(t)dt; and
S4: deducing therefrom the lifetime of the part, said lifetime corresponding to the final time.

Certain preferred but non-limiting features of the method described above are as follows, taken individually or in combination:
the step S1 of determining an average damage of the part as a function of time comprises a step S11 wherein are defined several different wears of the part, and comprises the following steps, carried out for each defined wear of the part:
   S12: determining a part geometry based on the wear defined in step S11, such as to determine a relationship expressing the part geometry as a function of wear,
   S13: determining stresses applied to the part based on the part geometry determined in step S12, such as to determine a relationship expressing the stresses applied to the part as a function of wear,
   S14: determining a lifetime at constant wear of the part based on the stresses applied to the part determined in step S13, such as to determine a relationship expressing the lifetime at constant wear of the part as a function of wear,
   S15: determining an average damage of the part based on the lifetime at constant wear of the part determined in step S14, such as to determine a relationship expressing the average damage of the part as a function of wear;
the step S1 of determining an average damage of the part as a function of time further comprises a step S16 consisting in determining the average damage of the part as a function of time based on the relationship expressing the average damage of the part as a function of wear, and of the relationship expressing the wear as a function of time;
the relationship expressing the average damage of the part as a function of wear is equal to the inverse of the relationship expressing the lifetime at constant wear of the part as a function of wear;
the method is implemented to evaluate the lifetime of a low-pressure compressor disc;
the relationship expressing the wear of the part as a function of time is a relationship expressing the wear depth as a function of time;
the damage at failure of the part is equal to 1.

### DESCRIPTION OF THE FIGURES

Other features, aims and advantages of this invention will become apparent on reading the following detailed description, given by way of non-limiting example, which will be illustrated by the following figures:

FIG. 1 is a block diagram representing the steps of a method according to an embodiment of the invention.

FIG. 2 is a block diagram representing steps for determining an average damage as a function of time according to an embodiment of the invention.

FIG. 3 is a graph illustrating the development of the lifetime of a part as a function of its wear, for a wear assumed constant over time, the lifetime being evaluated during a method according to an embodiment of the invention.

FIG. 4 is a graph illustrating the development of the average damage of a part as a function of its wear, for a wear assumed constant over time, the average damage being determined during a method according to an embodiment of the invention.

FIG. 5 is a graph illustrating the development of the average damage of a part as a function of time, the average damage being determined during a method according to an embodiment of the invention.

FIGS. 6a and 6b are side section views of a part of a turbomachine compressor comprising a part, the lifetime of which can be evaluated by an evaluation method according to an embodiment of the invention.

### DETAILED DESCRIPTION OF THE INVENTION

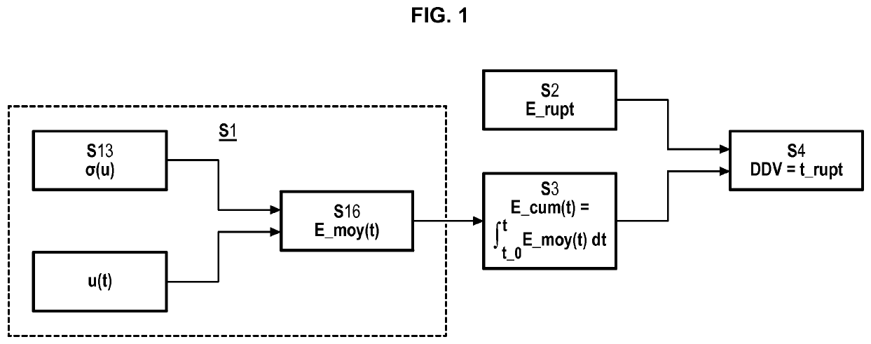

A method for evaluating a lifetime DDV of a turbomachine part, illustrated by way of non-limiting example in FIG. 1, comprises the following steps:
S1: determining an average damage of the part as a function of time E_moy(t) based on a relationship expressing the stresses applied to the part as a function of a wear of the part σ(u) and of a relationship expressing the wear of the part over time u(t);
S2: determining a damage at failure E_rupt of the part;
S3: determining a cumulative damage E_cum of the part corresponding to the damage at failure E_rupt of the part, said cumulative damage E_cum corresponding to the integral of the average damage as a function of time E_moy(t) between an initial t_0 and a final time t_rupt:

E_cum=E_rupt=∫_{t_0}^{t_rupt}E_moy(t)dt; and
S4: deducing therefrom the lifetime DDV of the part, said lifetime DDV corresponding to the final time t_rupt.

The average damage of the part as a function of time E_moy(t), which is used to determine the lifetime DDV of the part, is thus determined based on a relationship expressing the stresses applied to the part as a function of a wear of the part σ(u) and a relationship expressing the wear of the part as a function of time u(t).

Thus, the described method makes it possible to evaluate a lifetime DDV of the part, taking into account the development of the wear of the part during the operation of the turbomachine. The method can be applied to any turbomachine part, particularly any part having a wear developing with the turbomachine operating time. In particular, the method makes it possible to determine the damage, in propagation and incipient, of the part, when the wear of the part modifies the geometry thereof.

The described method makes it possible to take into account the fact that the development of the wear of the part causes a modification of the part geometry, and therefore of the stresses exerted on the part, and therefore of the lifetime of the part. Specifically, the greater the wear to the part, the greater the stresses within the part (stress concentration effect), so the greater the damage to the part per turbomachine operating cycle.

The described method thus makes it possible to evaluate the lifetime of a part more accurately than the models of the prior art. Thus, the flight time of the part before it is withdrawn from use for the purpose of repairing it or replacing it can be increased. In a variant or moreover, the manufacturing margins of the part can be reduced. The number of parts available at a given time is increased. The method therefore makes it possible to develop more efficient maintenance criteria, reduce maintenance costs and space maintenance operations on affected parts further apart.

Preliminary Concepts

The wear of the part corresponds to an alteration of the part related to its extended wear during the operation of the turbomachine. The wear can in particular be a mechanical wear generated by forces, rubbing and/or stresses undergone by the part during the operation of the turbomachine.

The wear can modify the part geometry, i.e. an outer surface of the part. For example, the wear can appear in the form of one or more rubbing marks locally hollowing out the part and/or in the form of outer surface irregularities.

The wear may be defined by a dimension of the wear. For example, the wear can be defined by a wear depth, i.e. a dimension of the wear in a direction normal to the direction of the plane tangent to the outer surface of the part at the wear. The part can have several areas of wear having several different wear depths, the wear depth then denoting the greatest depth among the wear depths of the several areas of wear of the part. In a variant or moreover, the wear can be defined by a wear length and/or a wear width. The wear can thus be defined by any combination of dimensions of the wear in any combination of directions.

The operating time can denote a number of operating cycles carried out by the turbomachine in which the part is assembled. A unit of time thus denotes a turbomachine operating cycle. An operating cycle can for example comprise a takeoff, a mission and a landing and be equivalent to a certain number of flight hours. In a variant, the operating time can denote a number of flight hours carried out by the turbomachine in which the part is assembled. One unit of time then denotes one flight hour.

The lifetime DDV of the part corresponds to the time that elapses before the failure of the part. The lifetime DDV thus denotes the number of units of time, for example the number of turbomachine operating cycles, that the part can withstand before its failure.

The failure of the part can be a physical failure of the part due to a wear of excessive dimensions, or be a wear of dimensions such that the part is no longer functional, and causes deterioration above a certain performance threshold of the turbomachine.

The damage to the part is determined based on the wear of the part which depends on the operating time, the damage being representative of the wear of the part.

The average damage of the part corresponds to a damage of the part per unit of time.

The cumulative damage of the part at a time t corresponds to the damage of the part after t units of time. The cumulative damage of the part varies between a new part damage E_neuf and a damage at failure E_rupt.

The new part damage E_neuf corresponds to the damage of an unworn part, for example of a part that has not yet undergone any operating cycles. The geometry of an unworn part therefore corresponds to the part geometry on leaving the factory. The new part damage E_neuf is determined at an initial operating time t_0 of the turbomachine, which can be equal to 0. Where applicable, the new part damage E_neuf can be equal to 0.

The damage at failure E_rupt corresponds to the damage of the part at the time its failure occurs. The damage at failure E_rupt therefore corresponds to a maximum damage of the part, at an operating time at failure t_rupt of the turbomachine which is equal to the lifetime DDV of the part. Where applicable, the damage at failure E_rupt of the part can be equal to 1.

Relationship Expressing the Wear as a Function of Time

The relationship expressing wear as a function of time u(t) corresponds to the wear kinematics of the part. The relationship expressing the wear as a function of time u(t) expresses the development of the wear over time of the part, i.e. the development of the dimensions of the wear with the turbomachine operating time. The relationship expressing the wear as a function of time u(t) therefore relates the dimensions of the wear, typically, the depth of the wear, to the number of units of time, in particular the number of turbomachine operating cycles. Specifically, the more the operating time of the turbomachine in which the part is assembled increases, the more the wear of the part increases.

In the following, the invention will be more specifically described for the case in which the relationship expressing the wear of the part as a function of time u(t) is a relationship expressing the wear depth as a function of time. This is, however, not limiting, since the relationship expressing the wear as a function of time u(t) can be a relationship expressing any combination of dimensions of the wear in any combination of envisionable directions, as specified above.

The relationship expressing the wear of a part as a function of time u(t) can be determined for example based on a database compiled from tests carried out on the part and/or based on a database compiled from data collected on the stock of parts assembled in turbomachines in operation. Where applicable, the relationship expressing the wear of a part as a function of time u(t) can take into account a statistical dispersion of the wear.

Determining the Average Damage of the Part as a Function of Time

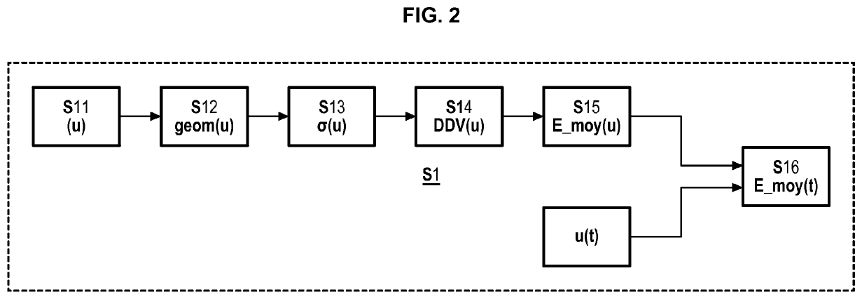

As illustrated by way of non-limiting example in FIG. 2, the step S1 of determining an average damage of the part as a function of time E_moy(t) may comprise a step S11 in which are defined several different wears u of the part and comprise the following steps, carried out for each defined wear u of the part:
S12: determining a part geometry based on the defined wear u in step S11, such as to determine a relationship expressing the part geometry as a function of wear geom(u),
S13: determining the stresses applied to the part based on the part geometry determined in step S12, such as to determine a relationship expressing the stresses applied to the part as a function of wear σ(u),
S14: determining a lifetime at constant wear of the part based on the stresses applied to the part determined in step S13, such as to determine a relationship expressing the lifetime of constant wear of the part as a function of wear DDV(u),
S15: determining an average damage of the part based on the lifetime at constant wear of the part determined in step S14, such as to determine a relationship expressing the average damage of the part as a function of wear E_moy(u).

Steps S12 to S15 of determining the geometry, stresses, lifetime at constant wear and average damage of the part, are repeated for each of the several defined wears u, such as to obtain corresponding relationships as a function of wear.

The defined wears u correspond to a mesh on the wear of the part. The defined number of defined wears u sets the fineness of the mesh. Thus, the greater the number of defined wears u, the more the average damage is determined for a large number of defined wears u, so the more accurate the definition of the relationship expressing the average damage of the part as a function of wear E_moy(u).

For example, the wears u defined during the step S11 may correspond to several defined wear depths. The determination of the average damage of the part can be done for each wear depth among the following defined wear depths u: 0 mm, 0.2 mm, 0.5 mm, 0.8 mm and 1 mm.

The relationship expressing the part geometry as a function of wear geom(u), determined owing to the repetition of the step S12 for each of the defined wears u, characterizes the variation of the part geometry as a function of its wear.

Specifically, the wear of the part modifies the part geometry, i.e. the outer surface of the part, for example by the appearance of rubbing marks characteristic of wear, of more or less large dimensions. The more the wear increases, the more the part geometry deviates from the part geometry on leaving the factory. A defined wear u thus has a defined part geometry that corresponds to it.

The relationship expressing the stresses applied to the part as a function of wear σ(u), determined by repeating steps S13 for each of the defined wears u characterizes the variation in the stresses applied to the part, i.e. stresses inside the part, as a function of its wear.

Specifically, the stresses applied to the part vary as a function of the part geometry, i.e. of the outer surface of the part, and therefore of the wear of the part. In particular, the stresses applied to the part increase when the dimensions of the wear increase. A worn part is therefore subjected to more stresses than a new part.

For a defined wear u, and therefore a defined part geometry, a set of stresses applied to the part is determined. The set of stresses applied to the part for a defined wear u can correspond to a stress field and be computed by a finite element model with modeling of the part geometry.

The step S1 of determining an average damage of the part as a function of time E_moy(t) may further comprise a step of determining the stresses applied to the part as a function of wear.

For each of the defined wears u, the stresses applied to the part are determined based on the stresses applied to the part and where applicable as a function of a temperature of the part during a unit of time. Thus, a relationship expressing the stresses applied to the part as a function of wear can be determined.

The relationship expressing the lifetime at constant wear of the part as a function of wear DDV(u), determined by repeating step S14 for each of the defined wears u, characterizes the variation of the lifetime at constant wear of the part as a function of its wear.

For a defined wear u, the lifetime at constant wear of the part corresponds to the number of units of time that the part can carry out while undergoing the determined stresses corresponding to the defined wear u, before its failure occurs. In other words, the lifetime at constant wear of the part for a defined wear u corresponds to the number of units of time, in particular to the number of operating cycles, before the failure of the part.

The lifetime at constant wear of the part is evaluated for a wear u defined of the part which is constant and does not develop over time. In other words, the lifetime at constant wear of the part is evaluated without taking into account the development of the wear of the part, and therefore of the part geometry, and therefore of the stresses applied to the part, with the turbomachine operating time.

For a defined wear u, the lifetime at constant wear of the part is evaluated based on thermomechanical stresses (stresses and temperatures) corresponding to the defined wear u. The lifetime at constant wear of the part can be determined on the basis of a model of propagation of wear and/or based on a database, in particular a database of materials tests establishing a correspondence between the thermomechanical stresses exerted on the part and the lifetime at constant wear of the part.

The relationship expressing the average damage of the part as a function of wear E_moy(u), determined by repeating step S15 for each of the defined wears u, characterizes the development of the average damage of the part as a function of wear.

For a defined wear u, the average damage of the part corresponds to an average damage of the part per unit of time, in particular to an average damage of the part during a turbomachine operating cycle.

The average damage of the part is determined for a defined wear u which is constant and does not develop over time. In other terms, the average damage of the part is evaluated without taking into account the wear of the part, and therefore of the part geometry, and therefore of the stresses applied to the part, and therefore of the lifetime of the part, with the turbomachine operating time.

For a defined wear u, an average damage of the part is determined based on the lifetime at constant wear determined in step S13.

The relationship expressing the average damage of the part as a function of wear E_moy(u) has an opposite direction of variation to the direction of variation of the relationship expressing the lifetime at constant wear of the part as a function of wear DDV(u). In other words, when the lifetime at constant wear of the part decreases, the average damage of the part per unit of time increases.

In an embodiment, the relationship expressing the average damage of the part as a function of wear E_moy(u) is equal to the inverse of the relationship expressing the lifetime at constant wear of the part as a function of wear DDV(u). The average damage of the part per unit of time is considered constant, i.e. the damage of the part is the same for each turbomachine operating cycle. The cumulative damage E_cum of the part for a defined wear u varies linearly over the turbomachine operating time, i.e. with the number of units of time.

In this embodiment, the cumulative new part damage E_neuf is equal to 0 at a turbomachine operating time t_0 equal to 0. The cumulative damage of the part at failure E_rupt is equal to 1 at a turbomachine operating time t_rupt equal to the part lifetime.

The relationship expressing the average damage of the part as a function of wear is then expressed in the following form:

$$E\_moy ( u ) = \frac{1}{DDV ( u )} .$$

Thus, for a defined wear u, the average damage of the part corresponds to the inverse of the lifetime at constant wear of the determined part for this defined wear u, i.e. the inverse of the number of units of time before the failure of the part. The average damage of the part is determined for each of the defined wears u.

The step S1 of determining an average damage of the part as a function of time may further comprise a step S16 consisting in determining the average damage of the part as a function of time E_moy(t) based on the relationship expressing the average damage of the part as a function of wear E_moy(u) and of the relationship expressing the wear as a function of time u(t).

The step S16 consisting in determining the average damage of the part as a function of time E_moy(t) may consist in replacing wear by time in the expression of the average damage of the part as a function of wear E_moy(u), based on the relationship expressing the wear of the part as a function of time u(t). This step S16 is thus akin to a change of variable, the wear variable being expressed as a function of the time variable. The relationship expressing the wear of the part as a function of time u(t) thus makes it possible to express the average damage as a function of time E_moy(t).

The average damage of the part as a function of time E_moy(t) corresponds to an average damage of the part per unit of time, in particular per turbomachine operating cycle.

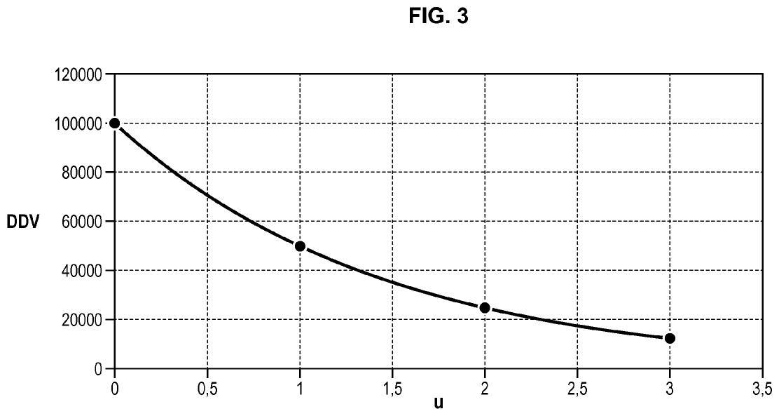

A particular embodiment is illustrated in FIGS. 3, 4 and 5. The time is expressed in the number of turbomachine operating cycles.

FIG. 3 is a graph showing by way of example the relationship expressing the lifetime at constant wear of a given part DDV(u). The lifetime at constant wear of this part is expressed in numbers of turbomachine operating cycles. The wear is characterized by the wear depth, which is expressed as a number of units of depth. The defined wears u respectively correspond to 0, 1, 2 and 3 units of depth. The evaluation of the lifetime at constant wear of the part, with the wear assumed to remain constant over the turbomachine operating time, is repeated for each of these defined wears u. The lifetime at constant wear of the part decreases when the wear of the part increases. Specifically, the more the part is worn, the greater the number of operating cycles it can undergo before its failure is reduced.

The relationship expressing the lifetime at constant wear DDV(u) is illustrated by a decreasing convex curve. The lifetime at constant wear of an unworn part, i.e. a part having a wear of 0 units of depth, is of 100 000 cycles. For this part, the lifetime at constant wear having a wear of 3 units of depth is of 12 500 cycles.

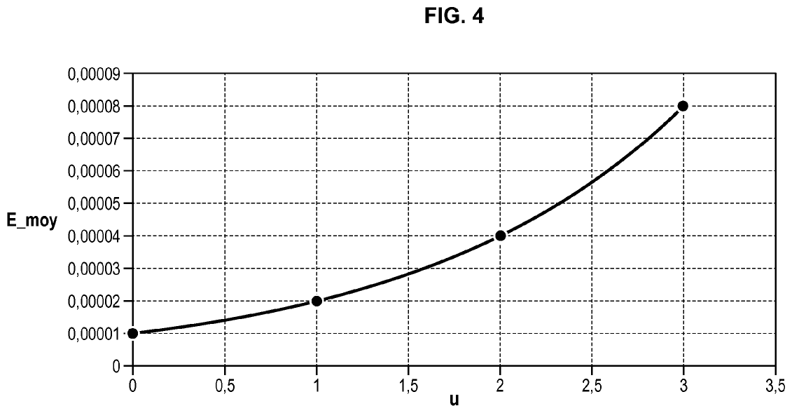

FIG. 4 is a graph showing the relationship expressing the average damage of this example of a part per unit of time as a function of wear depth E_moy(u). For each defined wear u, with the wear assumed to remain constant over the turbomachine operating time, the average damage of the part per unit of time corresponds to the inverse of the lifetime at constant wear obtained for the defined wear u. The average damage of the part increases with the wear depth. Specifically, the more the part is worn, the higher the stresses exerted on the part, so the greater the average damage of the part.

The relationship expressing the average damage of the part as a function of wear E_moy(u) corresponds to the inverse of the relationship expressing the lifetime at constant wear of the part as a function of wear DDV(u), and is an increasing convex curve. The average damage of the part per operating cycle for one wear of the part is 0 units of depth of the part is of 10⁻⁵, which corresponds to a lifetime at constant wear of 100 000 cycles. The average damage of the part per operating cycle for a wear of the part of 3 units of depth is of 8*10⁻⁵, which corresponds to a lifetime at constant wear of 12 500 cycles.

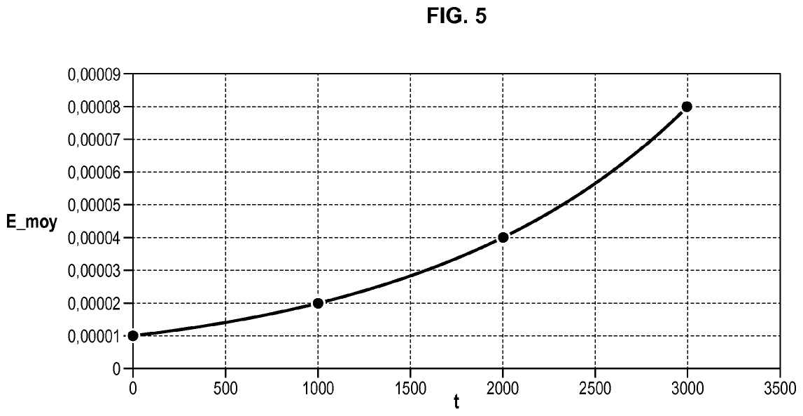

FIG. 5 is a graph showing the relationship expressing the average damage of the part per unit of time as a function of the operating time E_moy(t). The average damage of the part per unit of time E_moy(t) is determined by replacing wear by time in the expression of the average damage as a function of wear E_moy(u), based on the relationship expressing the wear for the time u(t).

The relationship expressing the wear for the operating time u(t) can be a linear relationship, the wear increasing by one unit of depth for 1000 turbomachine operating cycles. As a variant, the relationship expressing the wear for the operating time u(t) can be a non-linear relationship.

The average damage of the part as a function of time is an increasing convex function. The average damage of the part per operating cycle for a zero operating time t_0, corresponding to zero wear of the part, is of 10⁻⁵. The average damage of the part per operating cycle for an operating time of 3 000 cycles is of 8*10⁻⁵.

Determining the Lifetime of the Part

The cumulative damage of the part is determined at a time t, i.e. after t units of time, in particular after t operating cycles. The cumulative damage of the part at time t corresponds to the integral of the average damage as a function of time, between the initial time t_0 and the time t: E_cum(t)=∫_{t_0}^{t}E_moy(t)dt. The cumulative damage of the part after t units of turbomachine operating time is thus representative of a sum of the average damages of the part per unit of time over these t units of time.

The lifetime of the part DDV corresponds to the turbomachine operating time t_rupt at the time of failure of the part. In particular, the lifetime of the part DDV corresponds to the time elapsed between the initial turbomachine operating cycle t_0 for the new part, and the final operating turbomachine operating cycle t_rupt during which the failure of the part occurs.

The failure of the part occurs when the cumulative damage of the part is equal to the damage at failure of the part E_rupt. The lifetime DDV of the part therefore corresponds to the value of time t_rupt for which the integral of the average damage of the part per unit of time as a function of time, between the initial time t_0 and the time at failure t_rupt, corresponds to the damage at failure of the part: E_cum(t_rupt)=∫_{t_0}^{t_rupt}E_moy(t)dt=E_rupt.

In an embodiment, the initial time t_0 is equal to 0 and corresponds to a new part damage E_neuf equal to 0, the part having undergone no operating cycle and no damage at the initial time t_0. The damage at failure E_rupt is equal to 1.

The number of operating cycles after which the cumulative damage of the part is equal to 1 corresponds to the lifetime of the part DDV, i.e. to the number of operating cycles before failure t_rupt of the part. The value of the time to failure t_rupt can then be deduced from the following equation: ∫₀^{t_rupt}E_moy(t)dt=1. The value of the time at failure t_rupt, which is equal to the lifetime DDV of the part t_rupt=DDV, can therefore be deduced from the relationship expressing the average damage as a function of time E_moy(t).

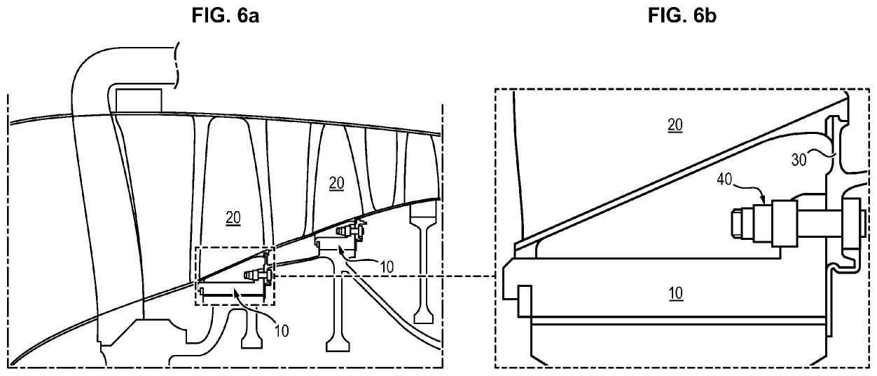

The method can for example be implemented to evaluate the lifetime DDV of a low-pressure compressor disc 10, such a low-pressure compressor disc 10 being illustrated by way of non-limiting example in FIGS. 6a and 6b. A low-pressure compressor disc 10 is rotationally secured about a turbomachine longitudinal axis of a set of low-pressure compressor blades 20 extending radially from the disc. In particular, a low-pressure compressor blade root 20 can be attached to the low-pressure compressor disc 10 at a bolted coupling 40.

A damper 30 can be disposed under the blade root 20, close to the attachment 40 of the blade 20 on the compressor disc 10. The damper 30 may comprise a damping sheet. The damper 30 attenuates the vibrations of the elements in contact with it.

A wear, in particular wears by small amounts of travel, can be caused on the low-pressure compressor disc 10 due to the contacts between the damper 30 and the disc 10 facing the corresponding blade 20.

The greater the number of operating cycles undergone by the low-pressure compressor disc 10, the more the wear increases. The geometry of the low-pressure compressor disc 10, i.e. its outer surface, is affected by the development of the wear. The method described below is used to evaluate the lifetime DDV of the low-pressure compressor disc 10, taking into account the variation of the part geometry 10 due to the development of the wear with time.

In a variant, the method can be applied to the evaluation of the lifetime DDV of any turbomachine part having a wear developing with time and stresses developing with wear.

1. A method for evaluating a lifetime of a turbomachine part, comprising the following steps:
S1: determining an average damage of the part as a function of time based on a relationship expressing the stresses applied to the part as a function of a wear of the part and of a relationship expressing the wear of the part as a function of time;
S2: determining a damage at failure of the part;
S3: determining a cumulative damage of the part corresponding to the damage at failure of the part, said cumulative damage corresponding to the integral of the average damage as a function of time between an initial time and a final time: E_cum=E_rupt=∫_{t_0}^{t_rupt} E_moy(t)dt; and
S4: deducing therefrom the lifetime of the part, said lifetime corresponding to the final time.

2. The method for evaluating a lifetime of a turbomachine part as claimed in claim 1, wherein the step S1 of determining an average damage of the part as a function of time comprises a step S11 wherein are defined several different wears of the part, and comprises the following steps, carried out for each defined wear of the part:
S12: determining a part geometry based on wear defined in step S11, such as to determine a relationship expressing the part geometry as a function of wear,
S13: determining stresses applied to the part based on the part geometry determined in step S12, such as to determine a relationship expressing the stresses applied to the part as a function of wear,
S14: determining a lifetime at constant wear of the part based on the stresses applied to the part determined in step S13, such as to determine a relationship expressing the lifetime at constant wear of the part as a function of wear,
S15: determining an average damage of the part based on the lifetime at constant wear of the part determined in step S14, such as to determine a relationship expressing the average damage of the part as a function of wear.

3. The method for evaluating a lifetime of a turbomachine part as claimed in claim 2, wherein the step S1 of determining an average damage of the part as a function of time further comprises a step S16 consisting in determining the average damage of the part as a function of time based on the relationship expressing the average damage of the part as a function of wear and of the relationship expressing the wear as a function of time.

4. The method for evaluating a lifetime of a turbomachine part as claimed in claim 2, wherein the relationship expressing the average damage of the part as a function of wear is equal to the inverse of the relationship expressing the lifetime at constant wear of the part as a function of wear (DDV(u)).

5. The method for evaluating a lifetime of a turbomachine part as claimed in claim 1, wherein the method is implemented to evaluate the lifetime (DDV) of a low-pressure compressor disc.

6. The method for evaluating a lifetime of a turbomachine part as claimed in claim 1, wherein the relationship expressing the wear of the part as a function of time (u(t)) is a relationship expressing the wear depth as a function of time.

7. The method for evaluating a lifetime of a turbomachine part as claimed in claim 1, wherein the damage at failure of the part is equal to 1.
